(19) United States
(12) Patent Application Publication
(10) Pub. No.: US 2012/0242342 A1
(43) Pub. Date: Sep. 27, 2012

(54) Correction of Deep Azimuthal Resistivity Measurements for Bending

(75) Inventors: Michael B. Rabinovich, Houston, TX (US); Leonty A. Tabarovsky, Cypress, TX (US)

(73) Assignee: Baker Hughes Incorporated, Houston, TX (US)

(21) Appl. No.: 13/420,269

(22) Filed: Mar. 14, 2012

Related U.S. Application Data
(60) Provisional application No. 61/454,865, filed on Mar. 21, 2011.

(51) Int. Cl. G01V 3/20

(52) U.S. Cl. 324/338

(57) ABSTRACT

A method and apparatus for estimating at least one parameter of interest in an earth formation using a signal from a receiver where a quadrature component of a signal at a plurality of frequencies is used to estimate a misalignment angle between the receiver and a transmitter. The apparatus may include at least one receiver, at least one transmitter, and at least one processor configured to excite the transmitter and estimate the misalignment angle. The method may include acquiring data at a plurality of frequencies, estimating a misalignment angle, and estimating at least one parameter of interest using the misalignment angle. The method may include performing multi-frequency focusing on the signal received at each of the plurality of frequencies.

### CROSS-REFERENCES TO RELATED APPLICATION

This application claims priority from U.S. Provisional Patent Application Ser. No. 61/454,865, filed on 21 Mar. 2011, which is incorporated herein by reference in its entirety.

### BACKGROUND OF THE DISCLOSURE

1. Field of the Disclosure

The present disclosure is related to the field of apparatus design in the field of oil exploration. In particular, the present disclosure describes a method for improving the measurements of deep reading multi-component logging devices used in boreholes measuring for formation resistivity properties and geosteering.

2. Description of the Related Art

Electromagnetic propagation resistivity well logging instruments are well known in the art. Electromagnetic propagation resistivity well logging instruments are used to determine the electrical conductivity, and its converse, resistivity, of earth formations penetrated by a borehole. Formation conductivity has been determined based on results of measuring the amplitude and/or phase of electromagnetic signals generated by a transmitter and the receiver in the borehole. The electrical conductivity is used for, among other reasons, inferring the fluid content of the earth formations and distances to bed boundaries. Typically, lower conductivity (higher resistivity) is associated with hydrocarbon-bearing earth formations. Deep reading propagation resistivity tools are also used for estimating distances to interfaces in the earth formation.

One, if not the main, difficulty in interpreting the data acquired by a deep azimuthal resistivity tool is associated with vulnerability of its response to misalignment of transmitter and antenna coils. The cross-component measurements are particularly sensitive to the misalignment. The misalignment can be caused by different factors such as limited accuracy of coil positioning during manufacturing or/and tool assembly as well as bending of the tool while logging. The bending effect can be significant for the deep reading azimuthal tools with large transmitter-receiver spacings. The problem is exacerbated when drilling deviated holes or during geosteering due to the curvature of the borehole.

### SUMMARY OF THE DISCLOSURE

One embodiment of the disclosure is a method of estimating a parameter of interest of an earth formation. A logging tool is conveyed into a borehole in the earth formation. A transmitter antenna with a first axial direction on the logging tool is excited at a plurality of frequencies. A signal resulting from the excitation is received at each of the frequencies using a receiver antenna having a second axial direction, which is different from the first axial direction. A misalignment angle between the transmitter antenna and the receiver antenna is estimated using a quadrature component from the signal at the plurality of frequencies.

Another embodiment of the disclosure is an apparatus for determining a parameter of interest of an earth formation. The apparatus includes a logging tool configured for conveyance in a borehole in the earth formation. A transmitter antenna configured for operation at a plurality of frequencies on the logging tool. A receiver antenna having an axial direction different from an axial direction of the transmitter antenna is configured to receive a signal resulting from the operation of the transmitter antenna at each of the frequencies. A processor configured to estimate, using the signal at each of the plurality of frequencies, a misalignment angle between the transmitter antenna and the receiver antenna.

Another embodiment of the disclosure is a non-transitory computer-readable medium product having instructions thereon that when read by a processor cause the processor to execute a method, the method comprising: estimating, using a multi-frequency focusing including a linear term in frequency, from quadrature signals received at a plurality of frequencies by a receiver on a logging tool in the borehole in an earth formation responsive to activation of a transmitter on the logging tool, a misalignment angle between the transmitter antenna and the receiver antenna.

### BRIEF DESCRIPTION OF THE DRAWINGS

The present disclosure is best understood with reference to the accompanying figures in which like numerals refer to like elements and in which:

FIG. 1 shows an induction logging instrument deployed in a borehole according to the present disclosure;

FIG. 2 illustrates the transmitter and receiver configuration of a deep reading azimuthal resistivity tool suitable for use with the disclosure of the present disclosure;

FIG. 3 illustrates a misalignment of the receiver oriented along the x-axis by an angle α;

FIG. 4 shows a model of a horizontal well which is parallel to a resistivity interface; and

FIG. 5 shows a flow chart of one embodiment of the present disclosure using quadrature signals.

### DETAILED DESCRIPTION OF THE DISCLOSURE

The instrument structure provided by the present disclosure enables increased stability and accuracy in a propagation resistivity tool and its operational capabilities, which, in turn, may result in better quality and utility of borehole data acquired during logging. The features of the present disclosure are applicable to improve the accuracy of an azimuthal resistivity tool.

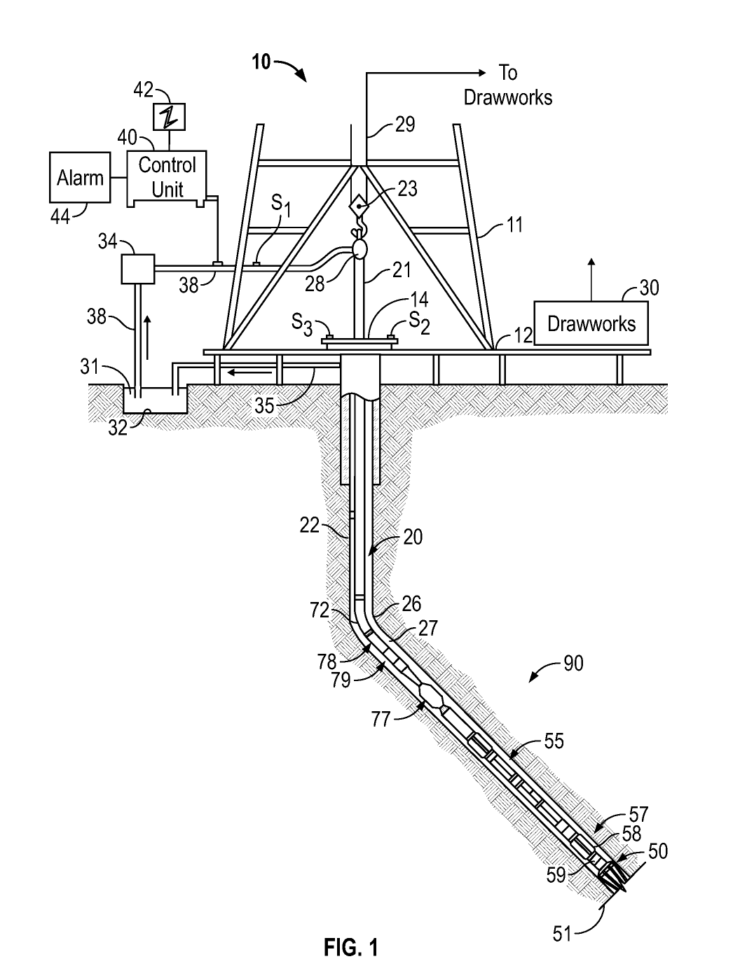

FIG. 1 shows a schematic diagram of a drilling system 10 with a carrier, such as drillstring 20, carrying a drilling assembly 90 (also referred to as the bottom hole assembly 90, or “BHA”) conveyed in a “wellbore” or “borehole” 26 for drilling the borehole. Exemplary non-limiting carriers 20 may include drill strings of the coiled tube type, of the jointed pipe type, and any combination or portion thereof. Other carrier examples include casing pipes, wirelines, wireline sondes, slickline sondes, drop shots, downhole subs, bottom hole assemblies (BHAs), drill string inserts, modules, internal housings, and substrate portions thereof.

The drilling system 10 includes a conventional derrick 11 erected on a floor 12 which supports a rotary table 14 that is rotated by a prime mover such as an electric motor (not shown) at a desired rotational speed. The drillstring 20 may include a tubing such as a drill pipe 22 or a coiled-tubing extending downward from the surface into the borehole 26. The drillstring 20 is pushed into the borehole 26 when a drill pipe 22 is used as the tubing. For coiled-tubing applications, a tubing injector, such as an injector (not shown), however, is used to move the tubing from a source thereof, such as a reel (not shown), to the borehole 26.

The drill bit 50 may be attached to the end of the drillstring and breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 may be operated to control the weight on bit, which is an important parameter that affects the rate of penetration. The operation of the drawworks 30 is well known in the art and is thus not described in detail herein.

During drilling operations, a suitable drilling fluid 31 from a mud pit (source) 32 may be circulated under pressure through a channel in the drillstring 20 by a mud pump 34. The drilling fluid may pass from the mud pump 34 into the drillstring 20 via a desurger (not shown), fluid line 38 and Kelly joint 21. The drilling fluid 31 is discharged at the borehole bottom 51 through an opening in the drill bit 50. The drilling fluid 31 may circulate uphole through the annular space 27 between the drillstring 20 and the borehole 26 and return to the mud pit 32 via a return line 35. The drilling fluid may lubricate the drill bit 50 and/or carry borehole cutting or chips away from the drill bit 50. A sensor S₁, optionally placed in the line 38, may provide information about the fluid flow rate. A surface torque sensor S₂ and a sensor S₃ associated with the drillstring 20, respectively, may provide information about the torque and rotational speed of the drillstring. Additionally, a sensor (not shown) associated with line 29 may be used to provide the hook load of the drillstring 20.

In one embodiment of the disclosure, the drill bit 50 is rotated by only rotating the drill pipe 22. In another embodiment of the disclosure, a downhole motor 55 (mud motor) is disposed in the drilling assembly 90 to rotate the drill bit 50 and the drill pipe 22 is rotated usually to supplement the rotational power, if required, and to effect changes in the drilling direction.

In the non-limiting embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 may support the radial and axial forces of the drill bit. A stabilizer 58 coupled to the bearing assembly 57 may act as a centralizer for the lowermost portion of the mud motor assembly.

In one embodiment of the disclosure, a drilling sensor module 59 is placed near the drill bit 50. The drilling sensor module 59 may contain sensors, circuitry, and processing software and algorithms relating to the dynamic drilling parameters. Such parameters preferably include bit bounce, stick-slip of the drilling assembly, backward rotation, torque, shocks, borehole and annulus pressure, acceleration measurements, and other measurements of the drill bit condition. A suitable telemetry or communication sub 72 using, for example, two-way telemetry, is also provided as illustrated in the drilling assembly 90. The drilling sensor module 59 processes the sensor information and transmits it to the surface control unit 40 via the telemetry system 72. Sensor information may include, but is not limited to, raw data, processed data, and signals.

The communication sub 72, a power unit 78 and an MWD tool 79 are all connected in tandem with the drillstring 20. Flex subs, for example, are used in connecting the MWD tool 79 in the BHA 90. Such subs and tools may form the BHA 90 between the drillstring 20 and the drill bit 50. The drilling assembly 90 makes various measurements including the pulsed nuclear magnetic resonance measurements while the borehole 26 is being drilled. The BHA may include an azimuthal resistivity tool 77. The communication sub 72 may obtain the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 preferably includes a computer or a microprocessor-based processing system, memory for storing programs or models and data, a recorder for recording data, and other peripherals. The control unit 40 is preferably adapted to activate alarms 44 when certain unsafe or undesirable operating conditions occur.

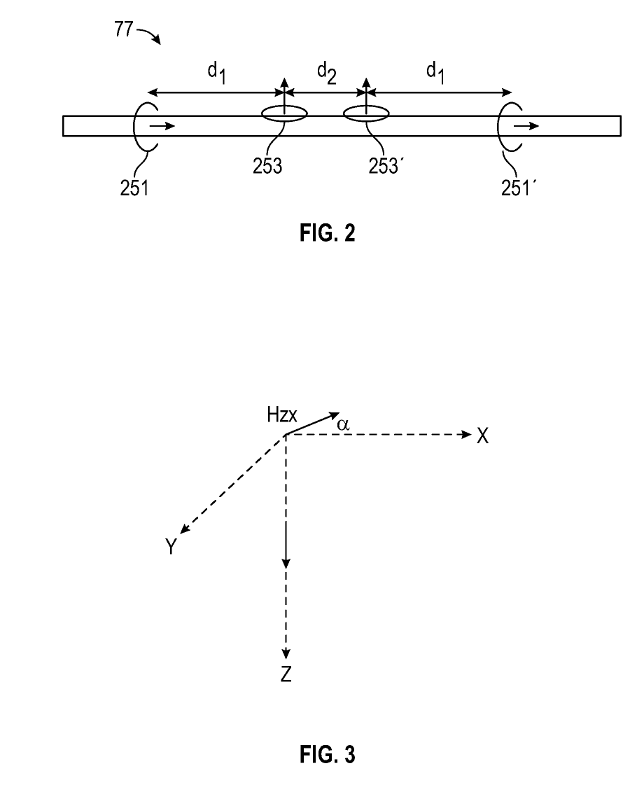

FIG. 2 shows an exemplary azimuthal resistivity tool 77 configured for use with the method of the present disclosure. The tool 77 may be conveyed on the BHA 90. The tool 77 may include one or more transmitter 251, 251′ whose dipole moments are oriented in a first axial direction and one or more receivers 253, 253′ oriented in a second axial direction. In some embodiments, the first axial direction may be parallel to the tool axis direction. In some embodiments, the second axial direction may be perpendicular to the first axial direction. In some non-limiting embodiments, the tool 77 may include a dual transmitter configuration, as shown in FIG. 2 and as has been discussed in U.S. Pat. No. 7,471,088 to Yu et al., having the same assignee as the present disclosure and the contents of which are incorporated herein by reference. Referring to an exemplary two receiver-two transmitter embodiment, when the first transmitter 251 is activated to produce an electromagnetic field in the Earth formation, the two receivers 253, 253′ may measure the magnetic field components. The two receivers 253, 253′ may also receive signals responding to activation of the second transmitter 251′. The signals may be combined in following way:

H_{T1}=H₂−(d₁/(d₁+d₂)³·H₁

H_{T2}=H₁−(d₁/(d₁+d₂))³·H₂ (1).

Here, H₁ and H₂ are the measurements from the first and second receivers 253, 253′, respectively, and the distances d₁ and d₂ are as indicated in FIG. 2. The azimuthal resistivity tool 77 may rotate with the BHA 90 and, in an exemplary mode of operation, makes measurements at 16 angular orientations 22.5° apart. The measurement point is at the center of two receivers 253, 253′. In a uniform, isotropic formation, no signal would be detected at either of the two receivers 253, 253′. It should further be noted that using well known rotation of coordinates, the method of the present disclosure also works with various combinations of measurements as long as they (i) correspond to signals generated from opposite sides of a receiver, and, (ii) can be rotated to give the principal cross components. It should further be noted that the two transmitter dual receiver configurations is for exemplary purposes only and the method of the present disclosure can also be practiced with a single transmitter and a single receiver.

Consider the H_{zx} measurement, where z- is the orientation of transmitter 251 and x- is the orientation of receiver 253. If the coils are properly aligned (exactly 90° between z and x coils) the response from the formation will be H_{ZXtrue}. If, however, the x-receiver is misaligned with the z-transmitter 251 by the angle α as shown in FIG. 3. Then the magnetic field measured in such array is:

H_{ZX}=H_{ZXtrue}·cos α−H_{ZZtrue}·sin α (2).

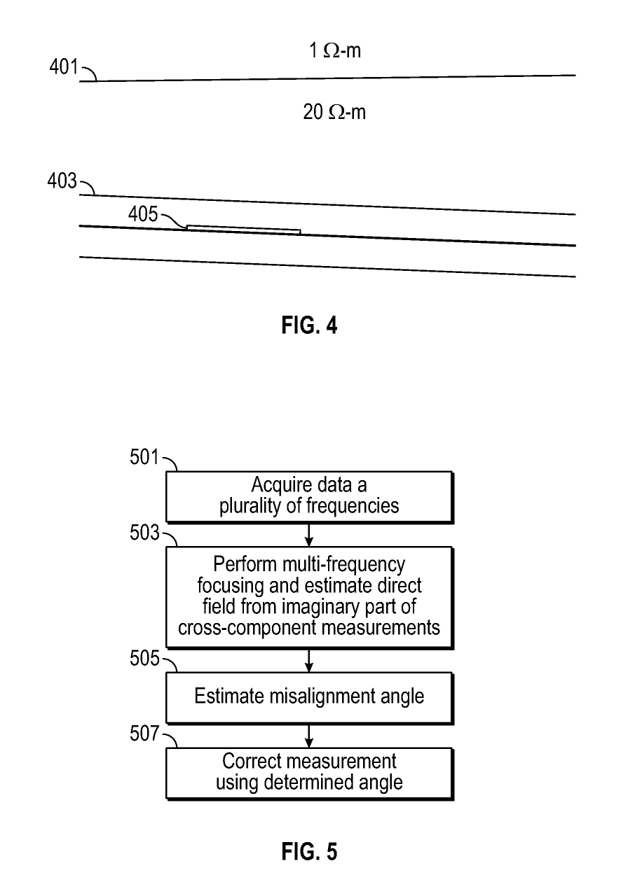

Even when misalignment angle is small (typically 1°-2°), misalignment error can be comparable with the true H_{zx} response. Consider the exemplary case of a borehole 403 shown in FIG. 4 with an angle of 1° to an interface 401. The borehole 403 is in an exemplary sand formation of resistivity 20 Ω-m at a depth of 5 m below a shale of resistivity 1 Ω-m on the other side of the interface 401. In the example, there is a transmitter-receiver spacing of 5 m in the tool 405 and an operating frequency of 20 kHz. Those versed in the art and having benefit of the present disclosure would recognize that with the large transmitter-receiver spacing, the likelihood of misalignment increases when curved boreholes are being drilled.

For the model of FIG. 4, the true response (quadrature component of the magnetic field for unit moment) for zz component is 1.13×10⁻⁴ A/m and for ZX component is 1.04×10⁻⁵ A/m. For a misalignment angle of 2°, the measured ZX signal will be given by:

H_{ZXmeasured}=1.04×10⁻⁵·cos 2°−1.13×10⁻⁴·sin 2°=0.68×1×10⁻⁵is A/m

In this example, it can be seen that in this case the misalignment error exceeds 30%. If the misalignment angle is known, Eqn. 2 can be used for correcting the measured ZX signal. Next, a way of estimating the misalignment angle and making corrections using the estimated misalignment angle is discussed.

Eqn. 2 can be used to analyze the quadrature signal due to misalignment. The response may consist of a linear combination of ZX and ZZ formation responses combined with coefficients depending on the misalignment angle. By extracting the constant (frequency independent) part of the ZX quadrature signal and comparing it with the total direct field, it is possible to find the misalignment angle.

For the model of FIG. 4, the values of the ZX quadrature formation response and the direct field for a 1° misalignment are presented in Table 1. It can be seen that in this case the formation response is comparable with the direct field, meaning that it would be very important to separate the direct field from the formation response to accurately estimate the misalignment angle.

TABLE 1
Comparison of the XY formation response and the
direct field caused by 1° misalignment

| | Direct field for 1° | |
|---|---|---|
| ZX formation response | misalignment | Formation relative |
| Re(H_{xy}) (A/m) | (A/m) | contribution % |
| −0.1693 * 10⁻⁴ | −0.2247 * 10⁻⁴ | 44.1 |

The separation of the direct field from the formation response in the quadrature signal may be achieved by applying a Taylor expansion used in multi-frequency focusing (MFF) of the real component of the signal. Using the method disclosed in U.S. Pat. No. 7,379,818 to Rabinovich et al., the following frequency expansion for the quadrature signal is obtained:

Re(H)=bₒ+b₁ω^{3/2}+b₂ω²+b₃ω^{5/2}+b₄ω^{7/2}+b₅ω⁴+b₆ω^{9/2} . . . (3)

In the present disclosure, a deep reading tool with large transmitter-receiver spacing is considered. Consequently, the low frequency assumptions made in Rabinovich may be less accurate at the scale of the tool size. An example of deviation from the classical frequency Eqn. (3) is considered in U.S. Pat. No. 7,031,839 to Tabarovsky et. al., In that case, the deviation is caused by the presence of a strong conductor in which the low frequency Eqn. (3) is not valid for all the practically meaningful frequencies.

Looking at the quadrature signal (real part) of the magnetic field for H_{zz} component in the same model (obtained by subtracting the direct field for clarity) for different frequencies, it can be seen (Table 2) that the responses are proportional to frequency, ω.

TABLE 2
H_{zz} formation response for different frequencies

| | Frequency (KHz) | | |
|---|---|---|---|
| | 10 | 20 | 40 |
| Re (H_{zz}) - direct | −2.21E−05 | −4.32E−05 | −8.48E−05 |
| field (A/m) | | | |

Based on this behavior Eqn. (3) is modified to a different form:

Re(H)=bₒ+b₁ω¹+b₂ω^{3/2}+b₃ω²+b₄ω^{5/2}+b₅ω³+b₆ω^{7/2}+b₇ω⁴+ . . . (4)

To make sure the Eqn. (4) is still valid for low frequency, results of the magnetic field calculations in the same models for frequencies two orders of magnitude smaller are shown in Table 3. It can be seen that the responses are proportional to frequency raised to an exponent of 1.5, ω^{3/2}.

TABLE 3
H_{zz} formation response for low frequencies

| | Frequency (KHz) | | |
|---|---|---|---|
| | 0.1 | 0.2 | 0.4 |
| Re (H_{zz}) - direct | −1.12E−07 | −2.77E−07 | −6.66E−07 |
| field (A/m) | | | |

It can be seen that the first term in Eqn. (4) (which is independent of frequency) represents the direct field. Hence if multi-frequency quadrature measurements are made, it is possible to extract this term using the same MFF method that is used for the standard multi-component processing, the difference being that different powers in the frequency series are used and the first coefficient is used instead of the second coefficient as in the prior art MFF.

To test the method, synthetic data were generated for the model presented above using 2 different misalignment angles: 1° and 2°. For each misalignment angle, the MFF was applied to extract the direct field from the data and based on this value, the misalignment angle was calculated. The results presented in Table 4 were obtained using signals at four frequencies (10, 20, 40 and 70 kHz) and 3 first terms in the Eqn. 4.

TABLE 4
Calculation of the misalignment angle for the Model 1.

| True | Extracted direct | | Calculated |
|---|---|---|---|
| misalignment | field | Total direct field | misalignment angle |
| angle (deg) | (A/m) | (A/m) | (deg) |
| 1 | −0.2204E−04 | 0.1273 * 10⁻² | 0.992 |
| 2 | −0.4424E−04 | 0.1273 * 10⁻² | 1.991 |

This embodiment of the disclosure may be represented by the flowchart of FIG. 5. In step 501, data may be acquired at a plurality of frequencies. As a specific example, the transmitter is a Z-transmitter 251 and the receiver is an X-receiver 253. In step 503, a MFF of the quadrature component of the magnetic (ZX) signal is performed using eqn. (4) to give the direct field between the transmitter 251 and the receiver 253. This may also be done using an equivalent formulation for the electric field using methods known to those versed in the art having the benefit of the present disclosure. In step 505, using the estimated direct field, the misalignment angle may be estimated. In step 507, the estimated misalignment angle may then be used to correct the individual single frequency measurements, including the in-phase components. It should be noted that while the description above has been made with respect to the ZX component, from reciprocity considerations, the method is equally valid for the XZ component.

Once the misalignment angle is estimated, all of the multi-component signals can be corrected for misalignment and used for interpreting formation resistivities and petrophysical parameters and distances to bed boundaries. The principles used for this interpretation are disclosed in Appendix A and have been discussed, for example, in U.S. Pat. No. 6,470,274 to Mollison et al., U.S. Pat. No. 6,643,589 to Zhang et al., U.S. Pat. No. 6,636,045 to Tabarovsky et al., the contents of which are incorporated herein by reference. Specifically, the parameters estimated may include horizontal and vertical resistivities (or conductivities), relative dip angles, strike angles, sand and shale content, and water saturation.

In one embodiment of the disclosure, the estimated distance to a bed boundary such as 401 may be used in reservoir navigation. The objective in reservoir navigation is to maintain the drill bit in a desired relationship with respect to a resistivity interface in the earth formation. The resistivity interface may be a fluid contact or, as in the example of FIG. 4, a permeability barrier associated with a resistivity interface. As an example, it may be desired to maintain the drill bit at a specific distance from the interface.

Implicit in the control and processing of the data is the use of a computer program on a suitable non-transitory computer-readable medium that enables the processor to perform the control and processing. The non-transitory computer-readable medium may include ROMs, EPROMs, EAROMs, Flash Memories, and Optical disks.

While the foregoing is directed to the specific embodiments of the disclosure, various modifications will be apparent to those skilled in the art. It is intended that all variations within the scope and spirit of the appended claims be embraced by the foregoing.

The following definitions are helpful in understanding the scope of the disclosure:
alignment: the proper positioning or state of adjustment of parts in relation to each other;
calibrate: to standardize by determining the deviation from a standard so as to ascertain the proper correction factors;
coil: one or more turns, possibly circular or cylindrical, of a current-carrying conductor capable of producing a magnetic field;
EAROM: electrically alterable ROM;
EPROM: erasable programmable ROM;
flash memory: a nonvolatile memory that is rewritable;
computer-readable medium: something on which information may be stored in a form that can be understood by a computer or a processor;
misalignment: the condition of being out of line or improperly adjusted; for the cross-component, this is measured by a deviation from orthogonality;
Optical disk: a disc-shaped medium in which optical methods are used for storing and retrieving information;
Position: an act of placing or arranging; the point or area occupied by a physical object
Quadrature signal: magnetic field—in phase with transmitter current, voltage −90° out of phase; and
ROM: Read-only memory.

### APPENDIX A

One of skill in the art would recognize that a response at multiple frequencies may be approximated by a Taylor series expansion of the form:

$$[ \begin{matrix}{σ}_{a} ( {ω}_{1} ) \\ {σ}_{a} ( {ω}_{2} ) \\ ⋮ \\ {σ}_{a} ( {ω}_{m - 1} ) \\ {σ}_{a} ( {ω}_{m} )\end{matrix} ] = [ \begin{matrix}1 & {ω}_{1}^{1 / 2} & {ω}_{1}^{3 / 2} & … & {ω}_{1}^{n / 2} \\ 1 & {ω}_{2}^{1 / 2} & {ω}_{1}^{3 / 2} & … & {ω}_{2}^{n / 2} \\ ⋮ & ⋮ & ⋮ & ⋱ & ⋮ \\ 1 & {ω}_{m - 1}^{1 / 2} & {ω}_{m - 1}^{3 / 2} & … & {ω}_{m - 1}^{n / 2} \\ 1 & {ω}_{m}^{1 / 2} & {ω}_{m}^{3 / 2} & … & {ω}_{n}^{n / 2}\end{matrix} ] [ \begin{matrix}{s}_{0} \\ {s}_{1 / 2} \\ ⋮ \\ {s}_{( n - 1 ) / 2} \\ {s}_{n / 2}\end{matrix} ] \qquad ( 5 )$$

where σ is conductivity, and s is a Taylor series coefficient.

In a one embodiment of the disclosure, the number m of frequencies is ten. In eqn. (5), n is the number of terms in the Taylor series expansion. This can be any number less than or equal to m. The coefficient s_{3/2} of the ω^{3/2} term (ω being the square of k, the wave number) may be generated by the primary field and is relatively unaffected by any inhomogeneities in the medium surround the logging instrument, i.e., it is responsive primarily to the formation parameters and not to the borehole and invasion zone. In fact, the coefficient s_{3/2} of the ω^{3/2} term is responsive to the formation parameters as though there were no borehole in the formation and may be used as an estimate of the skin-effect corrected transverse induction data. Specifically, these are applied to the Hₓₓ and H_{yy} components. Those versed in the art would recognize that in a vertical borehole, the H_{zz} and H_{yy} would be the same, with both being indicative of the vertical conductivity of the formation. In one embodiment of the disclosure, the sum of the Hₓₓ and H_{yy} is used so as to improve the signal to noise ratio (SNR). This MFF measurement is equivalent to the zero frequency value. As would be known to those versed in the art, the zero frequency value may also be obtained by other methods, such as by focusing using focusing electrodes in a suitable device.

The present method may use data from a High Definition Induction Logging (HDIL) tool having transmitter and receiver coils aligned along the axis of the tool. These data may be inverted using a method such as that taught by U.S. Pat. No. 6,574,562 to Tabarovsky et al, or by U.S. Pat. No. 5,884,227 to Rabinovich et al., the contents of which are fully incorporated herein by reference, to give an isotropic model of the subsurface formation. Instead of, or in addition to the inversion methods, a focusing method may also be used to derive the initial model. Such focusing methods would be known to those versed in the art and are not discussed further here. As discussed above, an HDIL tool is responsive primarily to the horizontal conductivity of the earth formations when run in a borehole that is substantially orthogonal to the bedding planes. The inversion methods taught by Tabarovsky '562 and by Rabinovich '227 are computationally fast and may be implemented in real time. These inversions give an isotropic model of the horizontal conductivities (or resistivities).

Using the isotropic model derived, a forward modeling is used to calculate a synthetic response of the 3DEX™ tool at a plurality of frequencies. A suitable forward modeling program for the purpose is disclosed in Tabarovsky and Epov “Alternating Electromagnetic Field in an Anisotropic Layered Medium” Geol. Geoph., No. 1, pp. 101-109. (1977). MFF may be applied to the synthetic data.

In the absence of anisotropy, the output of a model estimating vertical conductivity using horizontal conductivity should be identical to the output from inventing data using an initialized model. Denoting by σᵢₛₒ the MFF transverse component synthetic data from horizontal conductivity estimated by inverting the data and by σₘₑₐₛ, the skin-effect corrected field data from the estimated vertical conductivity using inversion, the anisotropy factor λ, is then calculated based on the following derivation:

The Hₓₓ for an anisotropic medium is given by

$${H}_{xx} = - \frac{M}{4 {L}^{3}} [ - {( \frac{L}{{δ}_{v}} )}^{2} + ( \frac{1}{3} + \frac{1}{λ} ) {( \frac{L}{{δ}_{h}} )}^{3} ] where \\ {δ}_{v} = \sqrt{\frac{2}{{ωμσ}_{v}}} , {δ}_{h} = \sqrt{\frac{2}{{ωμσ}_{h}}} , λ = \frac{{σ}_{h}}{{σ}_{v}} . \qquad ( 6 )$$

For a three-coil subarray,

$${H}_{xx} = - \frac{1}{4 π} ( \frac{1}{3} + \frac{1}{λ} ) {( \frac{{ωμσ}_{h}}{2} )}^{3 / 2} \sum {M}_{i} \qquad ( 7 )$$

Upon introducing the apparent conductivity for Hₓₓ this gives

$${σ}_{meas}^{3 / 2} = \frac{3}{4} ( \frac{1}{3} + \frac{1}{λ} ) {σ}_{h}^{3 / 2} or \\ ( {σ}_{meas}^{3 / 2} - {σ}_{iso}^{3 / 2} ) = {σ}_{h}^{3 / 2} ( \frac{1}{4} + \frac{3}{4 λ} - 1 ) = {σ}_{h}^{3 / 2} ( \frac{3}{4 λ} - \frac{3}{4} )$$

which gives the result

$$λ = \frac{1}{1 - \frac{4}{3} ( \frac{{σ}_{iso}^{3 / 2} - {σ}_{meas}^{3 / 2}}{{σ}_{t}^{3 / 2}} )} \qquad ( 8 )$$

where σₜ is the conductivity obtained from the HDIL data, i.e., the horizontal conductivity. The vertical conductivity may be obtained by dividing σₜ by the anisotropy factor from eqn. (6).

At this point we develop the principle component structure for measuring formation anisotropy in bedding planes when the borehole is not normal (perpendicular) to the bedding plane. Let us consider a Cartesian coordinate system, {1,2,3}, associated with the tool. The axis “3” is directed along the tool. In this system, the matrix of magnetic components, H_{T}, may be represented in the following form:

$${\hat{H}}_{T} = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) \qquad ( 9 )$$

For layered formations, the matrix, H_{T}, is symmetric. The three diagonal elements, h₁₁, h₂₂, and h₃₃, may be measured, and the non-diagonal elements are considered unknown. Using a Cartesian coordinate system, {x, y, z}, associated with the plane formation boundaries. The z-axis is perpendicular to the boundaries and directed downwards. In this system, the magnetic matrix may be presented as follows:

$${\hat{H}}_{M} = ( \begin{matrix}{h}_{xx} & {h}_{xy} & {h}_{xz} \\ {h}_{xy} & {h}_{yy} & {h}_{yz} \\ {h}_{xz} & {h}_{yz} & {h}_{zz}\end{matrix} ) \qquad ( 10 )$$

The formation resistivity is described as a tensor, ρ. In the coordinate system associated with a formation, the resistivity tensor has only diagonal elements in the absence of azimuthal anisotropy:

$$\hat{ρ} = ( \begin{matrix}{ρ}_{t} & 0 & 0 \\ 0 & {ρ}_{t} & 0 \\ 0 & 0 & {ρ}_{n}\end{matrix} ) \\ {ρ}_{t} = {ρ}_{xx} = {ρ}_{yy} , {ρ}_{n} = {ρ}_{zz} \qquad ( 11 )$$

The “tool coordinate” system (1-, 2-, 3-) can be obtained from the “formation coordinate” system as a result of two sequential rotations:
Rotation about the axis “2” by the angle θ, such that the axis “3” in a new position (let us call it “3′”) becomes parallel to the axis z of the “tool” system;
Rotation about the axis “3′” by the angle φ, such that the new axis “1” (let us call it “1′”) becomes parallel to the axis x of the tool system.

The first rotation is described using matrices θ and θ^{T}:

$$\hat{θ} = ( \begin{matrix}{C}_{θ} & 0 & {S}_{θ} \\ 0 & 1 & 0 \\ - {S}_{θ} & 0 & {C}_{θ}\end{matrix} ) , {\hat{θ}}^{T} = ( \begin{matrix}{C}_{θ} & 0 & - {S}_{θ} \\ 0 & 1 & 0 \\ {S}_{θ} & 0 & {C}_{θ}\end{matrix} ) \qquad ( 12 )$$

### Here, C_{θ}=cos θ, S_{θ}=sin θ

The second rotation is described using matrices φ and φ^{T}:

$$\hat{ϕ} = ( \begin{matrix}{C}_{ϕ} & - {S}_{ϕ} & 0 \\ {S}_{ϕ} & {C}_{ϕ} & 0 \\ 0 & 0 & 1\end{matrix} ) , {\hat{ϕ}}^{T} = ( \begin{matrix}{C}_{ϕ} & {S}_{ϕ} & 0 \\ - {S}_{ϕ} & {C}_{ϕ} & 0 \\ 0 & 0 & 1\end{matrix} ) \qquad ( 13 )$$

### Here, C_{φ}=cos φ, S_{φ}=sin φ

Matrices H_{M} (the formation coordinate system) and H_{T} (the tool coordinate system) are related as follows:

Ĥ^{T}=\hat{R}^{T}Ĥₘ\hat{R} (14)

\hat{R}^{T}=\hat{φ}^{T}\hat{θ}^{T}, \hat{R}=\hat{θ}φ (15)

It is worth noting that the matrix H_{M} contains zero elements:

h_{xy}=h_{xy}=0 (16)

It is also important that to note that the following three components of the matrix H_{M} depend only on the horizontal resistivity.

h_{xz}=f_{xz}(ρₜ), h_{yz}=f_{yx}(ρₜ), h_{zz}=f_{zz}(ρₜ) (17)

Two remaining elements depend on both horizontal and vertical resistivities.

hₓₓ=fₓₓ(ρₜ,ρₙ), h_{yy}=f_{yy}(ρₜ,ρₙ) (18)

Taking into account Equations (12), (13), (15) and (16), we can re-write Equation (14) as follows:

$$( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) = ( \begin{matrix}{C}_{ϕ} & {S}_{ϕ} & 0 \\ - {S}_{ϕ} & {C}_{ϕ} & 0 \\ 0 & 0 & 1\end{matrix} ) ( \begin{matrix}{C}_{θ} & 0 & - {S}_{θ} \\ 0 & 1 & 0 \\ {S}_{θ} & 0 & {C}_{θ}\end{matrix} ) ( \begin{matrix}{h}_{xx} & 0 & {h}_{xz} \\ 0 & {h}_{yy} & {h}_{yz} \\ {h}_{xz} & {h}_{yz} & {h}_{zz}\end{matrix} ) ( \begin{matrix}{C}_{θ} & 0 & {S}_{θ} \\ 0 & 1 & 0 \\ - {S}_{θ} & 0 & {C}_{θ}\end{matrix} ) ( \begin{matrix}{C}_{ϕ} & - {S}_{ϕ} & 0 \\ {S}_{ϕ} & {C}_{ϕ} & 0 \\ 0 & 0 & 1\end{matrix} ) \qquad ( 19 )$$

The following expanded calculations are performed in order to present Equation (19) in a form more convenient for analysis.

$${\hat{A}}_{1} = ( \begin{matrix}{C}_{θ} & 0 & {S}_{θ} \\ 0 & 1 & 0 \\ - {S}_{θ} & 0 & {C}_{θ}\end{matrix} ) ( \begin{matrix}{C}_{ϕ} & - {S}_{ϕ} & 0 \\ {S}_{ϕ} & {C}_{ϕ} & 0 \\ 0 & 0 & 1\end{matrix} ) = ( \begin{matrix}{C}_{θ} {C}_{ϕ} & - {C}_{θ} {S}_{ϕ} & {S}_{θ} \\ {S}_{ϕ} & {C}_{ϕ} & 0 \\ - {S}_{θ} {C}_{ϕ} & {S}_{θ} {S}_{ϕ} & {C}_{θ}\end{matrix} )$$

$${\hat{A}}_{2} = ( \begin{matrix}{h}_{xx} & 0 & {h}_{xz} \\ 0 & {h}_{yy} & {h}_{yz} \\ {h}_{xz} & {h}_{yz} & {h}_{zz}\end{matrix} ) ( \begin{matrix}{C}_{θ} {C}_{ϕ} & - {C}_{θ} {S}_{ϕ} & {S}_{θ} \\ {S}_{ϕ} & {C}_{ϕ} & 0 \\ - {S}_{θ} {C}_{ϕ} & {S}_{θ} {S}_{ϕ} & {C}_{θ}\end{matrix} ) = ( \begin{matrix}{C}_{θ} {C}_{ϕ} {h}_{xx} - {S}_{θ} {C}_{ϕ} {h}_{xz} & - {C}_{θ} {S}_{ϕ} {h}_{xx} + {S}_{θ} {S}_{ϕ} {h}_{xz} & {S}_{θ} {h}_{xx} + {C}_{θ} {h}_{xz} \\ {S}_{ϕ} {h}_{yy} - {S}_{θ} {C}_{ϕ} {h}_{yz} & {C}_{ϕ} {h}_{yy} + {S}_{θ} {S}_{ϕ} {h}_{yz} & {C}_{θ} {h}_{yz} \\ {C}_{θ} {C}_{ϕ} {h}_{xz} + {S}_{ϕ} {h}_{yz} - {S}_{θ} {C}_{ϕ} {h}_{zz} & - {C}_{θ} {S}_{ϕ} {h}_{xz} + {C}_{ϕ} {h}_{yz} + {S}_{θ} {S}_{ϕ} {h}_{zz} & {S}_{θ} {h}_{xz} + {C}_{θ} {h}_{zz}\end{matrix} )$$

$${\hat{A}}_{3} = ( \begin{matrix}{C}_{θ} & 0 & - {S}_{θ} \\ 0 & 1 & 0 \\ {S}_{θ} & 0 & {C}_{θ}\end{matrix} ) ( \begin{matrix}{C}_{θ} {C}_{ϕ} {h}_{xx} - {S}_{θ} {C}_{ϕ} {h}_{xz} & - {C}_{θ} {S}_{ϕ} {h}_{xx} + {S}_{θ} {S}_{ϕ} {h}_{xz} & {S}_{θ} {h}_{xx} + {C}_{θ} {h}_{xz} \\ {S}_{ϕ} {h}_{yy} - {S}_{θ} {C}_{ϕ} {h}_{yz} & {C}_{ϕ} {h}_{yy} + {S}_{θ} {S}_{ϕ} {h}_{yz} & {C}_{θ} {h}_{yz} \\ {C}_{θ} {C}_{ϕ} {h}_{xz} + {S}_{ϕ} {h}_{yz} - {S}_{θ} {C}_{ϕ} {h}_{zz} & - {C}_{θ} {S}_{ϕ} {h}_{xz} + {C}_{ϕ} {h}_{yz} + {S}_{θ} {S}_{ϕ} {h}_{zz} & {S}_{θ} {h}_{xz} + {C}_{θ} {h}_{zz}\end{matrix} )$$

The components of Â₃ may be expressed as:

a₁₁⁽³⁾=C_{θ}²C_{φ}hₓₓ−C_{θ}S_{θ}C_{φ}h_{xz}−C_{θ}S_{θ}C_{φ}h_{xz}−S_{θ}S_{φ}h_{yz}+S_{θ}²C_{φ}h_{zz}

[a₁₁⁽³⁾=C_{θ}²C_{φ}hₓₓ−2C_{θ}S_{θ}C_{φ}h_{xz}−S_{θ}S_{φ}h_{yz}+S_{θ}²C_{φ}h_{zz}](*)

a₁₂⁽³⁾=−C_{θ}²S_{φ}hₓₓ+C_{θ}S_{θ}S_{φ}h_{xz}+C_{θ}S_{θ}C_{φ}h_{xz}−S_{θ}C_{φ}h_{yz}−S_{θ}²S_{φ}h_{zz}

[a₁₂⁽³⁾=−C_{θ}²S_{φ}hₓₓ+2C_{θ}S_{θ}S_{φ}h_{xz}−S_{θ}C_{φ}h_{yz}−S_{θ}²S_{φ}h_{zz}](*)

a₁₃⁽³⁾=C_{θ}S_{θ}hₓₓ+C_{θ}²h_{xz}−S_{θ}²h_{xz}−C_{θ}S_{θ}h_{zz}

[a₁₃⁽³⁾=C_{θ}S_{θ}hₓₓ+(C_{θ}²−S_{θ}²)h_{xz}−C_{θ}S_{θ}h_{zz}](*)

[a₂₁⁽³⁾=S_{φ}h_{yy}−S_{θ}C_{φ}h_{yz}](*)

[a₂₂⁽³⁾=C_{φ}h_{yy}+S_{θ}S_{φ}h_{yz}](*)

[a₂₃⁽³⁾=C_{θ}h_{yz}](*)

a₃₁⁽²⁾=C_{θ}S_{θ}C_{φ}hₓₓ−S_{θ}²C_{φ}h_{xz}+C_{θ}²C_{φ}h_{xz}+C_{θ}S_{θ}h_{yz}−C_{θ}S_{θ}C_{φ}h_{zz}

[a₃₁⁽³⁾=C_{θ}S_{θ}C_{φ}hₓₓ+(C_{θ}²−S_{θ}²)C_{φ}h_{xz}+C_{θ}S_{θ}h_{yz}−C_{θ}S_{θ}C_{φ}h_{zz}](*)

a₃₂⁽³⁾=−C_{θ}S_{θ}S_{φ}hₓₓ+S_{θ}²S_{φ}h_{xz}−C_{θ}²S_{φ}h_{xz}+C_{θ}C_{φ}h_{yz}+C_{θ}S_{θ}S_{φ}h_{zz}

[a₃₂⁽³⁾=−C_{θ}S_{θ}S_{φ}hₓₓ−(C_{θ}²−S_{θ}²)S_{φ}h_{xz}+C_{θ}C_{φ}h_{yz}+C_{θ}S_{θ}S_{φ}h_{zz}](*)

α₃₃⁽³⁾=S_{θ}²hₓₓ+C_{θ}S_{θ}h_{xz}+C_{θ}S_{θ}h_{xz}+C_{θ}²h_{zz}

[a₃₃⁽³⁾=S_{θ}²hₓₓ+2C_{θ}S_{θ}h_{xz}+C_{θ}²h_{zz}](*)

Taking into account all the above calculations, Equation (19) may be represented in the following form:

$$( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) = ( \begin{matrix}{C}_{ϕ} & {S}_{ϕ} & 0 \\ - {S}_{ϕ} & {C}_{ϕ} & 0 \\ 0 & 0 & 1\end{matrix} ) ( \begin{matrix}{a}_{11}^{2} & {a}_{12}^{2} & {a}_{13}^{2} \\ {a}_{21}^{2} & {a}_{22}^{2} & {a}_{23}^{2} \\ {a}_{31}^{2} & {a}_{32}^{2} & {a}_{33}^{2}\end{matrix} )$$

The linear combination of the measurements, h₁₁, h₂₂, and h₃₃ may be considered principal components, however, in alternate embodiments, a linear combination of any of the measurements may be used. In this example, the principal components may be expressed as:

$$\{ \begin{matrix} {h}_{11} = {a}_{11}^{( 3 )} {C}_{ϕ} + {a}_{21}^{( 3 )} {S}_{ϕ} \\ {h}_{22} = - {a}_{12}^{( 3 )} {S}_{ϕ} + {a}_{22}^{( 3 )} {C}_{ϕ} \\ {h}_{33} = {a}_{33}^{( 3 )}\end{matrix} \qquad ( 20 )$$

More detailed representation yields:

h₁₁=C_{θ}²C_{φ}²hₓₓ−2C_{θ}S_{θ}C_{φ}²h_{xz}−S_{θ}C_{φ}S_{φ}h_{yz}+S_{θ}²C_{φ}²h_{zz}+S_{φ}²h_{yy}−S_{θ}C_{φ}S_{φ}h_{yz}

[h₁₁=C_{θ}²C_{φ}²hₓₓ+S_{φ}²h_{yy}−2C_{θ}S_{θ}C_{φ}²h_{xz}−2S_{θ}C_{φ}S_{φ}h_{yz}+S_{θ}²C_{φ}²h_{zz}] (21)

h₂₂=C_{θ}²S_{φ}²hₓₓ−2C_{θ}S_{θ}S_{φ}²h_{xz}+S_{θ}C_{φ}S_{φ}h_{yz}+S_{θ}²S_{φ}²h_{zz}+C_{φ}²h_{yy}+S_{θ}C_{φ}S_{φ}h_{yz}

[h₂₂=C_{θ}²S_{φ}²hₓₓ+C_{φ}²h_{yy}−2C_{θ}S_{θ}S_{φ}²h_{xz}+2S_{θ}C_{φ}S_{φ}h_{yz}+S_{θ}²S_{φ}²h_{zz}] (22)

[h₃₃=S_{θ}²hₓₓ+2C_{θ}S_{θ}h_{xz}+C_{θ}²h_{zz}] (23)

Expressions for each component, h₁₁, h₂₂, and h₃₃, contain two types of functions: some depending only on ρₜ, and some others depending on both, ρₜ and ρₙ. Equations (14)-(16) may be rewritten in the following form:

$$\begin{matrix}\{ \begin{matrix} {h}_{11} = {C}_{θ}^{2} {C}_{ϕ}^{2} {h}_{xx} + {S}_{ϕ}^{2} {h}_{yy} + {f}_{11} ( {ρ}_{t} ) \\ {h}_{22} = {C}_{θ}^{2} {S}_{ϕ}^{2} {h}_{xx} + {C}_{ϕ}^{2} {h}_{yy} + {f}_{22} ( {ρ}_{t} ) \\ {h}_{33} = {S}_{θ}^{2} {h}_{xx} + {f}_{33} ( {ρ}_{t} )\end{matrix} \\ Here , & ( 24 ) \\ \{ \begin{matrix} {f}_{11} ( {ρ}_{t} ) = - 2 {C}_{θ} {S}_{θ} {C}_{ϕ}^{2} {h}_{xz} - 2 {S}_{θ} {C}_{ϕ} {S}_{ϕ} {h}_{yz} + {S}_{θ}^{2} {C}_{ϕ}^{2} {h}_{zz} \\ {f}_{22} ( {ρ}_{t} ) = - 2 {C}_{θ} {S}_{θ} {S}_{ϕ}^{2} {h}_{xz} + 2 {S}_{θ} {C}_{ϕ} {S}_{ϕ} {h}_{yz} + {S}_{θ}^{2} {S}_{ϕ}^{2} {h}_{zz} \\ {f}_{33} ( {ρ}_{t} ) = 2 {C}_{θ} {S}_{θ} {h}_{xz} + {C}_{θ}^{2} {h}_{zz}\end{matrix} & ( 25 )\end{matrix}$$

Equations (24) may be linearly combined for form:

h=αh₁₁+βh₂₂+h₃₃ (26)

Detailed consideration of Equation (26) yields:

h=αC_{θ}²C_{φ}²hₓₓ+αS_{φ}²h_{yy}+αf₁₁(ρₜ)+βC_{θ}²S_{φ}²hₓₓ+βC_{φ}²h_{yy}+βf₂₂(ρₜ)+S_{θ}²hₓₓ+f₃₃(ρₜ)

h=(αC_{θ}²C_{φ}²+βC_{θ}²S_{φ}²+S_{θ}²)hₓₓ+(αS_{φ}²+βC_{φ}²)h_{yy}+αf₁₁(ρₜ)+βf₂₂(ρₜ)+f₃₃(ρₜ)

Coefficients, α and β, may be defined in such a way that the resulting linear combination, h, does not depend on the vertical resistivity. To achieve that, the following part of the expression for h may be set to null:

h_{f}=(αC_{θ}²C_{φ}²+βC_{θ}²S_{φ}²+S_{θ}²)hₓₓ(αS_{φ}²+βC_{φ}²)h_{yy}=0 (27)

Imposing the following conditions satisfies equation (27):

$$\{ \begin{matrix}α {C}_{θ}^{2} {C}_{ϕ}^{2} + β {C}_{θ}^{2} {S}_{ϕ}^{2} + {S}_{θ}^{2} = 0 \\ α {S}_{ϕ}^{2} + β {C}_{ϕ}^{2} = 0\end{matrix} \qquad ( 28 )$$

Coefficients α and β may then be calculated. The second Equation in (28) yields:

$$β = - \frac{{S}_{ϕ}^{2}}{{C}_{ϕ}^{2}} α \qquad ( 29 )$$

After substitution of Equation (29) in the first Equation of (28), we obtain:

$$α {C}_{θ}^{2} {C}_{ϕ}^{2} - ( \frac{{S}_{ϕ}^{2}}{{C}_{ϕ}^{2}} α ) {C}_{θ}^{2} {S}_{ϕ}^{2} + {S}_{θ}^{2} = 0 = α {C}_{θ}^{2} ( {C}_{ϕ}^{θ} - \frac{{S}_{ϕ}^{4}}{{C}_{ϕ}^{2}} ) + {S}_{θ}^{2} ⇒ α {C}_{θ}^{2} \frac{{C}_{ϕ}^{4} - {S}_{ϕ}^{4}}{{C}_{ϕ}^{2}} = - {S}_{θ}^{2} \\ ⇒ α {C}_{θ}^{2} \frac{( {C}_{ϕ}^{2} + {S}_{ϕ}^{2} ) ( {C}_{ϕ}^{2} - {S}_{ϕ}^{2} )}{{C}_{ϕ}^{2}} = - {S}_{θ}^{2} ⇒ α {C}_{θ}^{2} \frac{{C}_{2 ϕ}}{{C}_{ϕ}^{2}} = - {S}_{θ}^{2} \\ α = - \frac{{C}_{ϕ}^{2}}{{C}_{2 ϕ}} \frac{{S}_{θ}^{2}}{{C}_{θ}^{2}} \qquad ( 30 )$$

To obtain the coefficient, β, Equation (30) may be substituted in Equation (29):

$$\begin{matrix}β = \frac{{S}_{ϕ}^{2}}{{C}_{ϕ}^{2}} \frac{{C}_{ϕ}^{2}}{{C}_{2 ϕ}} \frac{{S}_{θ}^{2}}{{C}_{θ}^{2}} = \frac{{S}_{ϕ}^{2}}{{C}_{2 ϕ}} \frac{{S}_{θ}^{2}}{{C}_{θ}^{2}} \\ Finally , & ( 31 ) \\ \{ \begin{matrix}α = - \frac{{C}_{ϕ}^{2}}{{C}_{2 ϕ}} \frac{{S}_{θ}^{2}}{{C}_{θ}^{2}} \\ β = \frac{{S}_{ϕ}^{2}}{{C}_{2 ϕ}} \frac{{S}_{θ}^{2}}{{C}_{θ}^{2}}\end{matrix} & ( 32 )\end{matrix}$$

It is convenient to normalize coefficients, α and β. A normalization factor, κ, may be introduced as:

κ=\sqrt{1+α²+β²} (33)

Equation (20) may be presented in the form:

h_{f}=α′hₓₓ+β′h_{yy}+γ′h_{zz} (34)

Here, h_{f′}=h_{f}/κ, α′=α/κ, β′=β/κ, γ′=γ/κ. (35)

Calculations yield:

$${κ}^{2} = 1 + \frac{{C}_{ϕ}^{4}}{{C}_{2 ϕ}^{2}} \frac{{S}_{θ}^{4}}{{C}_{θ}^{4}} + \frac{{S}_{ϕ}^{4}}{{C}_{2 ϕ}^{2}} \frac{{S}_{θ}^{4}}{{C}_{θ}^{4}} = 1 + \frac{{C}_{ϕ}^{4} + {S}_{ϕ}^{4}}{{C}_{2 ϕ}^{2}} \frac{{S}_{θ}^{4}}{{C}_{θ}^{4}} = \frac{{C}_{2 ϕ}^{2} {C}_{θ}^{4} + ( {C}_{ϕ}^{4} + {S}_{ϕ}^{4} ) {S}_{θ}^{4}}{{C}_{2 ϕ}^{2} {C}_{θ}^{4}} \\ κ = \frac{\sqrt{{C}_{2 ϕ}^{2} {C}_{θ}^{4} + ( {C}_{ϕ}^{4} + {S}_{ϕ}^{4} ) {S}_{θ}^{4}}}{{C}_{2 ϕ} {C}_{θ}^{2}} \qquad ( 36 )$$

### Consequently,

$${γ}^{′} = \frac{{C}_{2 ϕ} {C}_{θ}^{2}}{\sqrt{{C}_{2 ϕ}^{2} {C}_{θ}^{4} + ( {C}_{ϕ}^{4} + {S}_{ϕ}^{4} ) {S}_{θ}^{4}}}$$

$${α}^{′} = - \frac{{C}_{ϕ}^{2}}{{C}_{2 ϕ}} \frac{{S}_{θ}^{2}}{{C}_{θ}^{2}} \cdot \frac{{C}_{2 ϕ} {C}_{θ}^{2}}{\sqrt{{C}_{2 ϕ}^{2} {C}_{θ}^{4} + ( {C}_{ϕ}^{4} + {S}_{ϕ}^{4} ) {S}_{θ}^{4}}} = - \frac{{C}_{ϕ}^{2} {S}_{θ}^{2}}{\sqrt{{C}_{2 ϕ}^{2} {C}_{θ}^{4} + ( {C}_{ϕ}^{4} + {S}_{ϕ}^{4} ) {S}_{θ}^{4}}}$$

$${β}^{′} = \frac{{S}_{ϕ}^{2}}{{C}_{2 ϕ}} \frac{{S}_{θ}^{2}}{{C}_{θ}^{2}} \cdot \frac{{C}_{2 ϕ} {C}_{θ}^{2}}{\sqrt{{C}_{2 ϕ}^{2} {C}_{θ}^{4} + ( {C}_{ϕ}^{4} + {S}_{ϕ}^{4} ) {S}_{θ}^{4}}} = \frac{{S}_{ϕ}^{2} {S}_{θ}^{2}}{\sqrt{{C}_{2 ϕ}^{2} {C}_{θ}^{4} + ( {C}_{ϕ}^{4} + {S}_{ϕ}^{4} ) {S}_{θ}^{4}}}$$

Finally:

$$( \begin{matrix}MFF ( {H}_{xx} ) \\ MFF ( {H}_{yy} ) \\ MFF ( {H}_{zz} )\end{matrix} ) = ( \begin{matrix}{a}_{1} & {a}_{2} & {a}_{3} & {a}_{4} \\ {b}_{1} & {b}_{2} & {b}_{3} & {b}_{4} \\ {c}_{1} & {c}_{2} & {c}_{3} & {c}_{4}\end{matrix} ) ( \begin{matrix}MFF ( {h}_{xx} ) \\ MFF ( {h}_{yy} ) \\ MFF ( {h}_{zz} ) \\ MFF ( {h}_{xz} )\end{matrix} ) \qquad ( 40 )$$

Here, κ′=\sqrt{C_{2φ}²C_{θ}⁴+(C_{φ}⁴+S_{φ}⁴)S_{θ}⁴} (38)

The coefficient, κ, degenerates under the following conditions:

θ=0, φ=π/4 [symbol] κ′=0 (39)

Using the derivation given above, conductivities may be derived for estimated values of dip, θᵣ, and azimuth φᵣ. The derivation above has been done for a single frequency data. MFF data is a linear combination of single frequency measurements so that the derivation given above is equally applicable to MFF data. It can be proven that the three principle 3DEX™ measurements, MFF processed, may be expressed in the following form:

$$\{ \begin{matrix}{α}^{′} = - \frac{{C}_{ϕ}^{2} {S}_{θ}^{2}}{{κ}^{′}} \\ {β}^{′} = \frac{{S}_{ϕ}^{2} {S}_{θ}^{2}}{{κ}^{′}} \\ {γ}^{′} = \frac{{C}_{2 ϕ} {C}_{θ}^{2}}{{κ}^{′}}\end{matrix} \qquad ( 37 )$$

The matrix coefficients of Eqn. 40 depend on θᵣ, φᵣ, and three trajectory measurements: deviation, azimuth and rotation.

The components of the vector in the right hand side of Eqn. 40 represent all non-zero field components generated by three orthogonal induction transmitters in the coordinate system associated with the formation. Only two of them depend on vertical resistivity: hₓₓ and h_{yy}. This allows us to build a linear combination of measurements, h₁₁, h₂₂ and h₃₃, in such a way that the resulting transformation depends only on h_{zz} and h_{xz}, or, in other words, only on horizontal resistivity. Let T be the transformation with coefficients α, β and γ:

T=αMFF(h₁₁)+βMFF(h₂₂)+γMFF(h₃₃) (41)

The coefficients α, β and γ must satisfy the following system of equations:

a₁α+b₁β+c₁γ=0

a₂α+b₂β+c₂γ=0

α²+β²+γ²=1 (42)

From the above discussion it follows that a transformation may be developed that is independent of the formation azimuth. The formation azimuth-independent transformation may be expressed as:

Tₒ=(h₁₁+h₂₂)sin² θ−h₃₃(1+cos² θ) (43)

where θ is the dip of the formation and Tₒ is the linear transformation to separate modes. With this transformation and the above series of equations the conductivity of the transversely anisotropic formation may be estimated.

What is claimed is:

1. A method of estimating a parameter of interest of an earth formation, the method comprising:
conveying a carrier into a borehole in the earth formation;
exciting a transmitter antenna on carrier at a plurality of frequencies, the transmitter antenna having a first axial direction;
receiving, at each of the plurality of frequencies, a signal responsive to the excitation with a receiver antenna having a second axial direction different from the first axial direction; and
estimating from the quadrature component of the signal at the plurality of frequencies a misalignment angle between the transmitter antenna and the receiver antenna.

2. The method of claim 1 wherein the first axial direction and the second axial direction are substantially orthogonal to each other.

3. The method of claim 1 wherein estimating the misalignment angle further comprises performing a multi-frequency focusing (MFF).

4. The method of claim 3 wherein the performing the MFF further comprises using a Taylor series expansion including a linear term in frequency.

5. The method of claim 4 wherein determining the misalignment angle further comprises using a constant term of the Taylor series expansion.

6. The method of claim 1 further comprising:
using the estimated misalignment angle for correcting at least one of: (i) an in-phase component of the received signal, or (ii) a quadrature component of the received signal, and producing a corrected signal.

7. The method of claim 6 further comprising using the corrected signal to estimate the parameter of interest of the earth formation.

8. The method of claim 1 wherein the parameter of interest is at least one of (i) a horizontal conductivity, (ii) a vertical conductivity, (iii) a horizontal resistivity, (iv) a vertical resistivity, (v) a relative dip angle, (vi) a strike angle, (vii) a sand fraction, (viii) a shale fraction, (ix) a water saturation or (x) a distance to an interface.

9. The method of claim 1 further comprising controlling a direction of drilling using measurements corrected by the estimated misalignment angle.

10. An apparatus configured to estimate a value of a parameter of interest of an earth formation, the apparatus comprising:
a carrier configured to be conveyed in a borehole in the earth formation;
a transmitter antenna on the carrier configured to be operated at a plurality of frequencies, the transmitter antenna having a first axial direction;
a receiver antenna having a second axial direction different from the first axial direction configured to receive a signal resulting from the operation of the transmitter antenna at each of the plurality of frequencies; and
a processor configured to estimate from a quadrature component of the signal at the plurality of frequencies a misalignment angle between the transmitter antenna and the receiver antenna.

11. The apparatus of claim 10 wherein the transmitter antenna and the receiver antenna are substantially orthogonal to each other.

12. The apparatus of claim 10 wherein the processor is further configured to estimate the misalignment angle by performing a multi-frequency focusing (MFF).

13. The apparatus of claim 9 wherein the processor is configured to estimate the misalignment angle by further representing the signal at each of the plurality of frequencies by a Taylor series expansion including a linear term in frequency.

14. The apparatus of claim 13 wherein the processor is configured to estimate the misalignment by using a constant term of the Taylor series expansion

15. The apparatus of claim 10 wherein the processor is further configured to use the estimated misalignment angle to correct at least one of: (i) an in-phase of the received signal, or (ii) a quadrature components of the signal, and produce a corrected signal.

16. The apparatus of claim 15 wherein the processor is further configured to use the corrected signal to estimate the parameter of interest of the earth formation.

17. The apparatus of claim 16 wherein the parameter of interest is at least one of (i) a horizontal conductivity, (ii) a vertical conductivity, (iii) a horizontal resistivity, (iv) a vertical resistivity, (v) a relative dip angle, (vi) a strike angle, (vii) a sand fraction, (viii) a shale fraction, (ix) a water saturation and (x) a distance to an interface.

18. The apparatus of claim 9 further the carrier is selected from: (i) a wireline, or (ii) a BHA on a drilling tubular.

19. A non-transitory computer-readable medium product having instructions thereon that when read by a processor cause the processor to execute a method, the method comprising:
estimating, using a multi-frequency focusing including a linear term in frequency, from quadrature signals received at a plurality of frequencies by a receiver on a logging tool in the borehole in an earth formation responsive to activation of a transmitter on the logging tool, a misalignment angle between the transmitter antenna and the receiver antenna.

20. The non-transitory computer-readable medium product of claim 19 further comprising at least one of (i) a ROM, (ii) an EPROM, (iii) an EAROMs, (iv) a flash memory, or (v) an Optical disk.
